(19) United States
(12) Patent Application Publication
(10) Pub. No.: US 2007/0297070 A1
(43) Pub. Date: Dec. 27, 2007

(54) PROJECTOR

(75) Inventor: Hitoshi SHIMIZU, Saitama-shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, Saitama-shi (JP)

(21) Appl. No.: 11/769,095

(22) Filed: Jun. 27, 2007

(30) Foreign Application Priority Data
Jun. 27, 2006 (JP) 2006-176504

(51) Int. Cl. G02B 15/14

(52) U.S. Cl. 359/701

(57) ABSTRACT

A projection lens barrel assembly comprises a rotatable cam barrel with cam slots and a restraining slot formed by cutting and a stationary lens barrel formed as a resin product made by injection molding. A restraining roller which is attached to the stationary lens barrel by a support shaft is received in the restraining slot so as thereby to restrain rotational movement of the rotatable cam barrel when the restraining roller strikes ends of the restraining slot.

### BACKGROUND OF THE INVENTION

1. Field of the Invention

The present invention relates to a projector for projecting an image on a remote screen.

2. Description of Related Art

A lens barrel assembly for use with a projector comprises a stationary barrel having axial guide slots as an inner barrel, a cam barrel having circumferential cam slots for zooming in which the stationary lens barrel is fitted, and at least one lens holder received for axial movement in the stationary lens barrel. The stationary lens barrel at its end has a mounting flange through which the lens barrel assembly is mounted to the projector body. A projection lens system comprises at least one or more movable lens elements held by the lens holder. The lens holder, ring-shaped or barrel-shaped, has at least one cam follower roller in engagement with the axial guide slot of the stationary lens barrel and the cam slot of the rotatable cam barrel. When rotating the rotatable cam barrel, the lens holder is moved in axial direction through engagement between the cam follower roller and the cam slot, so that the projection lens system changes, for example, its focal length for zooming. The stationary lens barrel is generally provided as a resin product made by injection molding for the purpose of bringing down costs. On the other hand, the cam slot of the rotatable cam barrel is shaped by cutting because of a requirement of high precision.

In recent years, the projector shows a tendency to be provided with a zoom lens having a high zoom ratio. In order for the zoom lens to have a high zoom ratio, lens barrels, i.e. a stationary lens barrel and a rotatable lens barrel, have to have long length. At the same time, the problem encountered by a long stationary lens barrel is that the stationary lens barrel is devoid of stability in a mounted posture. It is conceived as one of attempt solutions of the problem to interchange inner and outer barrels, i.e. a stationary lens barrel and a rotatable cam barrel, with each other. That is, the rotatable cam barrel is placed inside the stationary lens barrel. In this case, the stationary lens barrel has a trunnion or collar formed away from an end thereof in place of the mounting flange and a restraining slot for restraining rotational movement of the rotatable cam barrel. The restraining slot receives a restraining roller provided on the rotatable cam barrel so that the restraining slot at opposite ends is struck by the restraining roller when the rotatable cam barrel is rotated to its extreme ends of rotational movement.

In the case where the stationary barrel is formed as a resin product made by injection molding, it is general that a mold has a poring gate at the back thereof. Therefore, when performing injection molding, a molten resin poured in the mold flows in from the back side to the front side. In consequence, in the case where the restraining slot extends crosswise with respect to the longitudinal direction of the stationary lens barrel, a flow of the molten resin slows down around the restraining slot. This slowing down of a flow of the molten resin brings about aggravation of injection molding stability and, hence, makes it hard to take strict dimensional control of restraining slots. Dimensional distortion of the restraining slot accounts for defective rotational movement of the rotatable cam barrel which results in defective axial movement of movable lens componets.

### SUMMARY OF THE INVENTION

It is therefore an object of the present invention to provide a projector with a projection lens barrel which enables to place a stationary lens barrel formed as a resin product made by injection molding outside a rotatable cam barrel.

The foregoing object of the present invention is accomplished by a projector equipped with a projection lens barrel assembly which includes a projection lens system comprising a plurality of movable lens components and which comprises a rotatable cam barrel in which the projection lens system is incorporated and which has cam slots for causing relative movement of the movable lens components in an axial direction when the rotatable cam barrel is rotated, a stationary lens barrel made in the form of resin product in which the rotatable cam barrel is laid for rotational movement, and restraining means for restraining rotational movement of the rotatable cam barrel, the restraining means comprising a circumferential restraining slot formed in the rotatable cam barrel, a restraining member movable in the circumferential restraining slot and a support shaft attached to the stationary lens barrel for mounting the restraining member thereon, wherein the rotatable cam barrel is prevented from causing further rotational movement of the rotatable cam barrel when the restraining member strikes either one of opposite ends of the circumferential restraining slot. An example of the resin used for the stationary lens barrel includes polycarbonate. The support shaft may be provided as a separate member from the stationary lens barrel or as an integral member with the stationary lens barrel. It is preferred to form the cam slots and the restraining slot in the rotatable cam barrel by cutting the rotatable cam barrel and to use aluminum or brass for the rotatable cam barrel.

It is preferred that the restraining member comprises a roller mounted for rotation on the support shaft and that the roller is made of polyacetal or brass. Further, it is preferred that the support shaft comprises a sleeve shaft on which the roller is mounted for rotation and a retaining member attached to the stationary lens barrel and engaged with the sleeve shaft so as thereby to retain the roller in the circumferential restraining slot. The retaining member may comprise a bolt or a resin rivet.

According to the lens barrel assembly having the configuration described above, it is enabled to lay the stationary lens barrel outside the rotatable cam barrel even though the stationary lens barrel is provided as a resin product made by injection molding. Furthermore, it is enabled to provide the stationary lens barrel with the annular collar formed away from an end of the barrel, so that the stationary lens barrel is firmly mounted with increased stability even when having a long axial length in order to provide wide ranges of axial movement of the movable lens components, respectively.

### BRIEF DESCRIPTION OF THE DRAWINGS

The foregoing and other objects and features of the present invention will be clearly understood from the following detailed description when reading with reference to the accompanying drawings in which same or similar parts or units are denoted by the same reference numerals and wherein:

FIG. 1 is an outline view of a projector equipped with a lens barrel assembly according to an embodiment of the present invention;

FIG. 2 is a schematic view of an internal formation of the projector;

FIG. 3 is a perspective view of a lens barrel assembly according to an embodiment of the present invention;

FIG. 4 is a perspective view of a rotatable cam barrel of the lens barrel assembly;

FIG. 5 is a perspective view of a lens unit of the lens barrel assembly;

FIG. 6 is a perspective view of a stationary lens barrel of the lens barrel assembly;

FIG. 7A is a cross-sectional view of the lens barrel assembly including a projection lens system in which a restraining roller is unincorporated; and

FIG. 7B is a cross-sectional view of the lens barrel assembly including a projection lens system in which the restraining roller is incorporated.

### DETAILED DESCRIPTION OF THE PREFERRED EMBODIMENTS

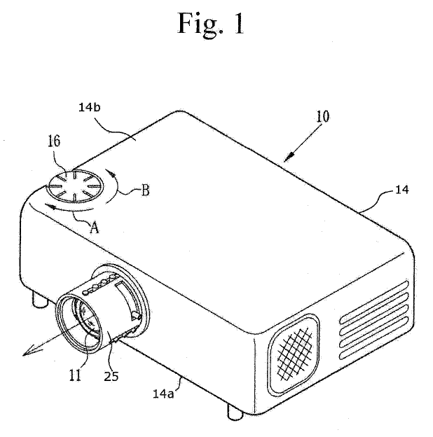

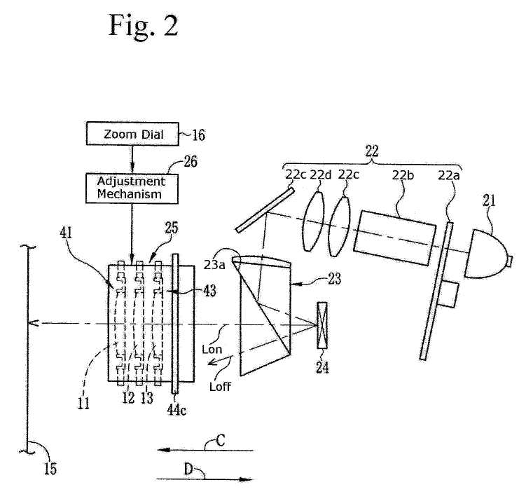

Referring to the accompanying drawings in detail and, in particular, to FIG. 1 showing a projector 10 equipped with a lens barrel assembly 25 according to an embodiment of the present invention, the projector 10 has a lens barrel assembly 25 attached to a front wall 14a of a projector housing 14 and a zoom dial 16 installed to a top wall 14b of the projector housing 14. The lens barrel assembly 25, which includes a projection lens system, for example a zoom lens system comprising lens 1 elements 11, 12 and 13 in this embodiment (see FIG. 2) incorporated therein, is covered by a lens cap (not shown) while it is in nonuse. The zoom dial 16 is turned in opposite directions A and B by a user to change a focal length of the zoom lens system comprises three lens units, namely a first lens unit 41, a second lens unit 42 and a third lens units 43.

Referring to FIG. 2, the projector 10 is provided with a projection system comprising, besides the lens barrel assembly 25, a light source 21, an illuminating lens system 22, a refection optical element 23 formed in a combination of prisms and a DMD 24, and a zoom ratio adjusting mechanism 26 all of which are installed in the projector housing 14. The light source 21 includes a while lamp such as a xenon lamp, a mercury lamp or the like. The illuminating lens system 22 comprises a color wheel 22a, a rod integrator 22b, relay lenses 22c and 22d and a reflection mirror 22e. The color wheel 22a, which is rotated at a high speed to separate a light beam from the light source 21 into three primary colors, B, G and R, in time sharing system so as thereby to transmit B, G and R light rays in order. For example, the color wheel 22a may comprise B, G and R transmission filter sections arranged alternately at regular angular intervals. The rod integrator 22b is made of, for example, glass and has an internal reflection surface. The rod integrator 22b uniformizes the individual primary color light rays which travel therethrough repeating internal reflections. The individual primary color light rays coming out of the rod integrator 22b are directed toward the reflection mirror 22c by the relay lenses 22c and 22d and then reflected and directed toward the total refection optical element 23 by the reflection mirror 22c. The illuminating lens system 22 is known in various forms and takes any form well known in the art.

The total reflection optical element 23 comprises two triangular prisms having different refractive indexes which are shaped and combined with each other so as to form an interface 23a therebetween. More specifically, the total reflection optical element 23 is adapted to cause a light beam reflected by the reflection mirror 22c to impinge upon the interface 23a at an incident angle greater than a critical angle and a light beam reflected by the DMD 24 to impinge upon the interface 23a at an incident angle smaller than the critical angle. Accordingly, the total reflection optical element 23 causes total internal reflection of a light beam incident upon the interface 23a and permits a light beam reflected by the DMD 24 and incident upon the interface 23a to travel passing therethrough. DMD 24 comprises a number of reflective mirror elements arranged in a matrix pattern thereon. The reflective mirror elements are independently changeable in reflection angle according to image signals. Specifically, each reflective mirror element is changed in posture between an active position where a light impinging thereupon is reflected as an on-axis light ray Lon gathered by the zoom lens system and an inactive position where a light impinging thereupon is reflected as an off-axis light ray Loff unseizable by the zoom lens system. When projecting a picture element of an image bright, the reflective mirror element corresponding to the picture element is put in the active position so as thereby to reflect a light within a field of view of the zoom lens system. On the other hand, when projecting a picture element of an image dark, the reflective mirror element corresponding to the picture element is put in the inactive position so as thereby to reflect a light out of the field of view of the zoom lens system. The zoom lens system projects an optical image by gathering on-axial light rays Lon from the DMD 24. These total reflection optical element 23 and DMD 24 are known in various forms and may take any forms well known in the art.

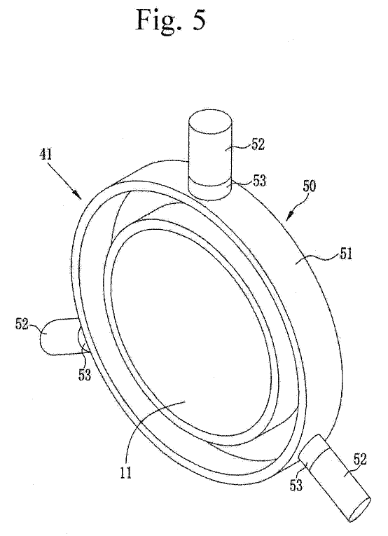

As shown in FIG. 2, the zoom lens system incorporated in the lens barrel assembly 25 for projecting an image onto a projection screen 15 remote from the projector 10 comprises three lens component, namely first to third movable lens components 11, 12 and 13 in order from a side of the projection screen 15. The lens barrel assembly 25 comprises a stationary lens barrel 44 mounted, fixedly or detachably, to the projector housing 14 and a rotatable lens barrel 40 received for rotational movement in the stationary lens barrel 44. The zoom lens system may comprise more or less than three lens components and the individual lens component may consist of a single lens element or a compound lens element or may consist of a plurality of lens elements. The first to third movable lens components 11, 12 and 13 are fixedly held by lens holder 50 to form first to third lens unit 41, 42 and 43, respectively, which are received for movement in opposite axial directions indicated by reference symbols C and D in the rotatably lens barrel 40 as will be described later. The lens holders 50 are the same in structure and operation as one anther and shown in FIG. 5.

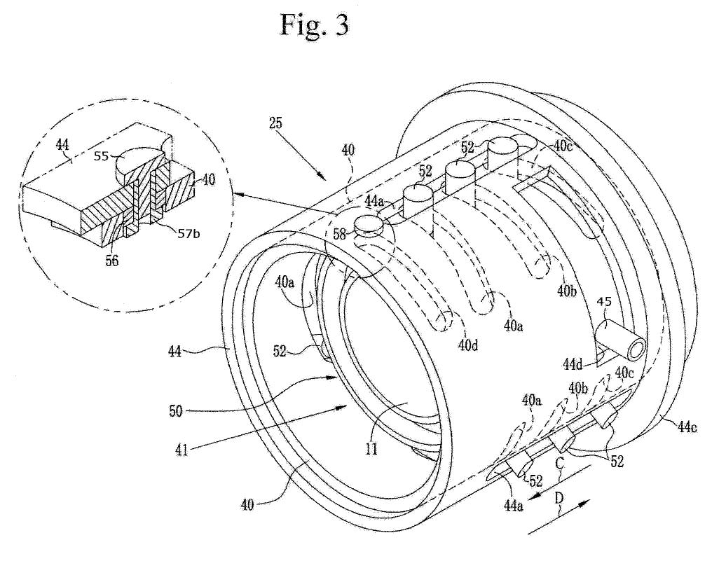

FIGS. 3 to 6 shows the lens barrel assembly 25 comprising the rotatable cam barrel 40 and the stationary lens barrel 44 in which the zoom lens system is installed for axial movement in detail. As apparent in FIG. 5 showing the first lens unit 41 for explaining the lens holder 50 holding the first lens component 11 as an example, the lens holder 50 comprises a holder ring 51 and three cam follower rollers 52 mounted for rotation on base supports 53 fixedly attached to the holder ring 51 at regular angular intervals or pitches of 120°.

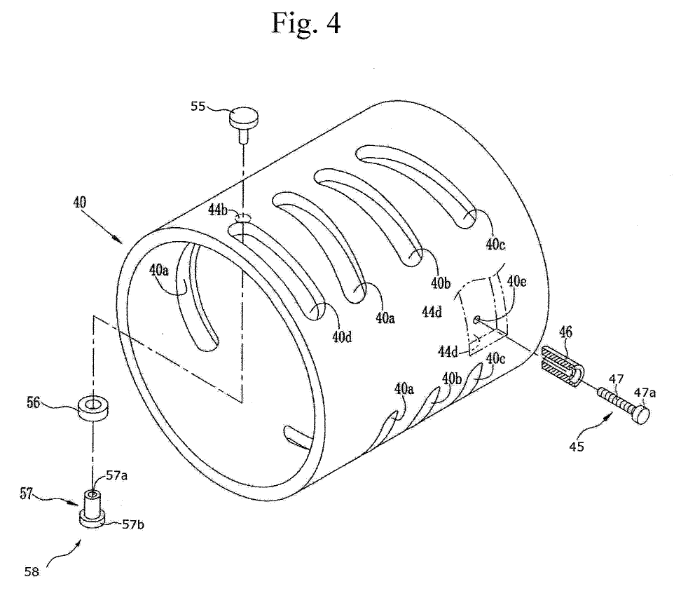

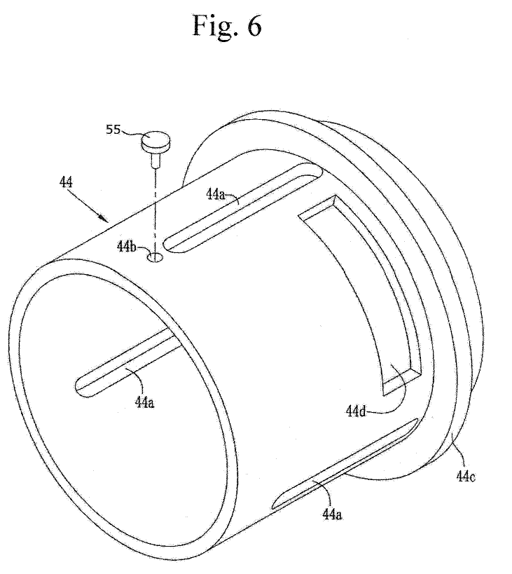

As shown in FIG. 3 and 4, the rotatable cam barrel 40, which is made of an aluminum die casting, has three pairs of circumferential cam slots 40a, 40b and 40c which have cam profiles different from one another and are cut and arranged at regular angular intervals or pitches of 120° in the circumferential direction and one circumferential restraining slot 40d. Further, the rotatable cam barrel 40 is provided with an operating or zoom lever 45 attached thereto. The cam slots 40a, 40b and 40c receive the cam follower rollers 52 of the individual lens units 41,42 and 43, respectively, and allow them to move therein. The operating lever 45 comprises a resin sleeve 46a rotatably mounted on an attaching bolt 47 screwed into a threaded bore 40e of the rotatable cam barrel 40. The attaching bolt 47 has a bolt head 47a for preventing the resin sleeve 46a from falling away the bolt stem. As shown in FIG. 6, the stationary lens barrel 44, which is formed as a resin product such as a polycarbonate product by injection molding, has three axial guide slot 44a arranged at regular angular intervals or pitches of 120° for receiving the cam follower rollers 52 of the individual lens units 41, 42 and 43, respectively, and allow them to move axially and a circumferential restraining opening 44d for allowing the operating lever 46 to move in a circumferential direction. Further, the stationary lens barrel 44 is provided with an annular trunnion or annular collar 44c formed away from an end thereof and a restraining head assembly 58 attached to the cam barrel 41. The lens barrel assembly 25 is detachably or fixedly mounted to the projector 10 by attaching the annular collar 44c to a mounting frame in the projector housing 14. The retaining head assembly 58 comprises a restraining ring roller 56, a sleeve shaft 57 having a threaded bore 57a and an end collar 57b which is fitted in a bore 44b of the stationary lens barrel 44 which the restraining ring roller 56 is totatably mounted, and a fitting bolt 55 screwed into the threaded bore 57a of the sleeve shaft 57. The restraining ring roller 56 is received for rotation in the restraining slot 40d of the rotatable cam barrel 40 and is interposed between the end collar 57b of the sleeve shaft 57 and an inner wall of the stationary lens barrel 44. The restraining ring roller 56 has an inner diameter so as to be snugly mounted on the sleeve shaft 57, an outer diameter so as to move in the restraining slot 40d of the rotatable cam barrel 40 smoothly and without rattling along, and a thickness less than a wall thickness of the rotatable cam barrel 40 so that the end collar of the sleeve shaft 57 is partly received in the restraining slot 40d of the rotatable cam barrel 40.

The cam follower roller 52 has a length sufficiently enough to pass rough the cam slot 40a, 40b, 40c of the cam barrel 40 and received in the axial guide slot 44a of the stationary lens barrel 44 but not stands out of the stationary lens barrel 44. With this configuration, relative rotation between the cam barrel 40 and the stationary lens barrel 44, which is produced by manual operation of the operating lever 45 or by manual operation of the zoom dial 16 through the zoom ratio adjusting mechanism 26, causes the first to third lens units 41, 42 and 43 to shift their axial positions according to the individual cal slots 40a, 40b and 40c, respectively. The cam slots 40a, 40b and 40c and the restraining slot 40d are formed so that the cam follower rollers 52 are prevented from striking any ends of the individual cam slots 40a, 40b and 40c even when the restraining roller 56 strikes either one of opposite ends of the restraining slot 40d. Specifically, relative rotation between the rotatable cam barrel 40 and the stationary lens barrel 44 causes the first to third lens units 41, 42 and 43 to change their axial positions according to the different cam slots 40a, 40b and 40c, respectively. In other words, the zoom lens system varies its zoom ratio according to an angle of relative rotation between the rotatable cam barrel 40 and the stationary lens barrel 44 and attains a given minimum or a given maximum zoom ratio when the restraining slot 40d at an end is struck by the restraining roller 56.

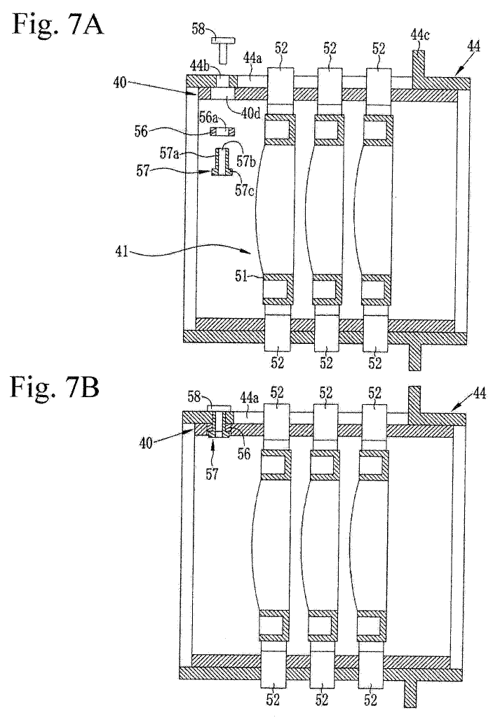

Assembling operation of the projection lens barrel 25 having the above configuration is described below with reference to FIGS. 7A and 7B. First of all, the first lens unit 41 with the cam follower rollers 52 removed therefrom is installed in the rotatable cam barrel 40 inserted in the stationary lens barrel 4. Subsequently, after attaching the operating lever 45 to the rotatable cam barrel 40 and laying the axial guide slots 44a of the stationary lens barrel 44 and the cam slots 40a, 40b and 40c of the rotatable cam barrel 40 to overlap crosswise each other, the cam follower rollers 52 are passed through the axial guide slots 44a and the cam slots 40a and attached to the base supports 53. In this wise, the first lens unit 41 is incorporated in the lens barrel assembly 25. The second and third lens units 42 and 43 are incorporated in the lens barrel assembly 25 in this order in the same manner as the first lens unit 41.

Thereafter, the restraining head assembly 58 is attached to the lens barrel assembly 25. Specifically, after placing the restraining ring roller 56 within the restraining slot 40d of the rotatable cam barrel 40, the sleeve shaft 57 is inserted into the restraining ring roller 56 until entering the restraining slot 40d, and then, screwing the fitting bolt 55 into the threaded bore 57a of the sleeve shaft 57 so as thereby to retain the restraining ring roller 56 between the end collar 57b of the sleeve shaft 57 and the inner wall of the stationary lens barrel 44.

In operation of the projector 10, when turning the zoom dial 16 in one of the opposite directions A and B, the zoom ratio adjusting mechanism 26 rotates the rotatable cam barrel 40 with respect to the stationary lens barrel 44 so as to cause axial movement of the first to third lens units 41, 42 and 43 through engagement between the cam follower rollers 52 of the individual lens units 41, 42 and 43 and the cam slots 40a, 40b and 40c of the movable cam barrel 40, respectively. In consequence, the projection lens system varies its zoom ratio according to an angle of rotation of the rotatable cam barrel 40 for zooming in or out of an optical image to be projected on the remote screen 15. When turning the zoom dial 16 in the direction A or B to one of critical zoom ratios, i.e. a maximum zoom ratio or a minimum zoom ratio, the restraining roller 56 strikes either one of opposite ends of the restraining slot 40d, so as thereby to prevent the cam follower rollers 52 from striking any end of the individual cam slots 40a, 40b and 40c, respectively.

As just described above, since the lens barrel assembly 25 has an arrangement in which the restraining roller 56 is received for rotation in the restraining slot 40d of the rotatable cam barrel 40 which is formed by cutting the rotatable cam barrel 40 and is retained between the end collar 57b of the sleeve shaft 57 and the inner wall of the stationary lens barrel 41 through engagement between the sleeve shaft 57 fitted in the bore 44b of the stationary lens barrel 44 formed as a resin product by injection molding and the fitting bolt 55, it is realized to lay the stationary lens barrel 44 outside the rotatable cam barrel 40 while being formed as a resin product by injection molding. Furthermore, the stationary lens barrel 44 with the annular collar 44c formed away from the end thereof is mounted to the mounting frame in the projector housing 14 through the annular collar 44c. In consequence, the stationary lens barrel 44 is firmly mounted to the projector 10 with increased stability even when having a long axial length in order to provide wide ranges of axial movement of the first to third lens units 41, 42 and 43, respectively.

In the above embodiment, the retaining head assembly 58 is provided by attaching the sleeve shaft 57 to the stationary lens barrel 44 by screwing the fitting bolt 55 into the threaded bore 57a of the sleeve shaft 57. However, the retaining head assembly 58 is not limited to this particular structure. That is, it is good enough to attach the restraining ring roller 56 mounted on the sleeve shaft 57 to the stationary lens barrel 44. For example, the sleeve shaft 57 may be fixed to the stationary lens barrel 44 by means of a resin rivet having end fingers. The restraining ring roller 56 may also be fixedly mounted on the sleeve shaft 57 as long as it moves in the restraining slot 40d of the rotatable cam barrel 40 smoothly and without rattling along. Further, in the above embodiment, the retaining head assembly 58 is structured so as to place the restraining ring roller 56 by the use of the sleeve shaft 57 and the fitting bolt 55. However, the retaining head assembly 58 is not limited to this particular structure as long as the restraining ring roller 56 is in the restraining slot 40d of the rotatable cam barrel 40. For example, the restraining ring roller 56 may be supported by a single member or by a member integrally formed with the stationary lens barrel 44.

The present invention is suitable for use on all types of optical instruments having a lens barrel assembly and has particular application in the projector and herein described in this context. However, it should be appreciated that the invention has broader application and is not limited to this particular use.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A projector equipped with a projection lens barrel assembly including a projection lens system for projecting an optical image on a remote screen which comprises a plurality of movable lens components, said projection lens barrel assembly comprising:
a rotatable cam barrel in which said projection lens system is incorporated and which has cam slots for causing relative movement of said movable lens components in an axial direction when said rotatable cam barrel rotates;
a stationary lens barrel made in the form of resin product in which said rotatable earn barrel is laid for rotational movement; and
restraining means for restraining rotational movement of said rotatable cam barrel, said restraining means comprising a circumferential restraining slot formed in said rotatable cam barrel, a restraining member movable in said circumferential restraining slot and a shaft attached to said stationary lens barrel for mounting said restraining member thereon;
wherein said rotatable cam barrel is prevented from causing further said rotational movement when said restraining member strikes either one of opposite ends of said circumferential resting slot.

2. The projector as defined in claim 1, wherein said cam slots are formed in said rotatable cam barrel by cutting said rotatable cam barrel

3. The projector as defined in claim 1, wherein said restraining member comprises a roller mounted for rotation on said shaft.

4. The projector as defined in claim 3, wherein said shaft comprises a sleeve shaft on which said roller is mounted for rotation and a retaining member attached to said stationary lens barrel and engaged with said sleeve shaft so as thereby to retain said roller in said circumferential restraining slot.
